(19) United States
(12) Patent Application Publication
(10) Pub. No.: US 2012/0187347 A1
(43) Pub. Date: Jul. 26, 2012

(54) ELECTRODE STRUCTURE FOR AN ENERGY STORAGE DEVICE

(76) Inventors: Thor E. Eilertsen, Oneonta, NY (US); Eun-Sung Lee, Oneonta, NY (US); Yong-Ho Jung, Songpa-gu (KR); Chad Hall, Walton, NY (US)

(21) Appl. No.: 12/991,602

(22) PCT Filed: May 8, 2009
(86) PCT No.: PCT/US09/43259

§ 371 Date: Feb. 29, 2012

(30) Foreign Application Priority Data
May 8, 2008 (US) 12/151811

(51) Int. Cl. H01B 1/24

(52) U.S. Cl. 252/511

(57) ABSTRACT

An electrode material composition for use in manufacturing energy storage device electrodes includes an active material, a conductive material including Ketjen Black, a binder comprising at least one of a polymer emulsion dispersed in water and a water-soluble polymer mixture, and a surfactant. The electrodes are manufactured by thy-mixing the active material and the conductive material to form a thy-mixed active material mixture. The drymixed active material mixture is then mixed with a binder solution to form a slurry and the slurry is coated onto a currently collector and dried to form an electrode.

### CROSS-REFERENCE TO RELATED CASE

This application claims priority to and is a continuation-in-part of U.S. patent application Ser. No. 12/151,811, filed May 8, 2008, the entirety of which is incorporated herein by reference.

### TECHNICAL FIELD

The present invention relates to electrodes, and more particularly, to an electrode for an electric double layer capacitor, pseudocapacitor, or battery that lowers the electrical resistance of the electrode with less conductive material, allowing for more active material thereby increasing the capacitance. A method of manufacturing the electrode, an electric double layer capacitor, a pseudocapacitor, and a battery incorporating the electrode are provided.

### BACKGROUND INFORMATION

A variety of electrochemical devices are currently being used to store electrical energy and to power industrial and electronic equipment. Secondary batteries, such are lead acid, nickel cadmium (NiCd), nickel hydrogen (NIH₂), nickel metal hydride (NiMH), lithium ion (Li-ion), and lithium ion polymer (Li-ion polymer) are widely used as power source of vehicles, especially oversized or special vehicles, electric apparatus, and other various kinds of industrial equipment, and their demand has steadily increased in recent years.

Electric double-layer capacitors (EDLC) have a variety of commercial applications, notably in “energy smoothing” and momentary-load devices. Some of the earliest uses were motor startup capacitors for large engines in tanks and submarines, and as the cost has fallen they have started to appear on diesel trucks and railroad locomotives. More recently they have become a topic of some interest in the green energy world, where their ability to soak up energy quickly makes them particularly suitable for regenerative braking applications, whereas batteries have difficulty in this application due to slow charging rates.

Another example of an energy storage devices that combines battery and capacitor technology is knows as the pseudocapacitor. While EDLCs only store energy electrostatically, pseudocapacitors can also store energy through a chemical reaction whereby a faradic charge transfer occurs between the electrolyte and electrode. Pseudocapacitors are asymmetrical in that one of the two electrodes is a carbon based capacitor electrode while the second electrodes is made from a metal oxide similar to those used in secondary batteries. Both of these energy storage mechanisms are highly reversible and can be charged and discharged thousands of times but the electric double-layer capacitors has the greater lifetime capability of millions of charge and discharge cycles.

### SUMMARY OF THE INVENTION

EDLCs offer significantly higher power density than batteries, however, their energy density is lower than most batteries. Although pseudocapacitors generally have a higher energy density than EDLCs, they still have lower energy densities that most batteries. It is thus desirable to enhance the performance characteristics of EDLCs, pseudocapacitors, and batteries, by increasing in the energy density per volume.

The easiest way to increase the energy density of electrical storage devices is to increase the relative amount of active material. However, in order to increase the amount of active material, the amount of conductive material must be decreased and the conductive material is essential in decreasing the electrical resistance of the electrode, increasing the conductivity, and thereby preventing static electricity. The drawback of this method is that decreasing the conductive material and increasing the amount of active material increases electrical resistance. Accordingly, there is a need to develop a method that can decrease the amount of the conductive material and at the same time prevent an increase in the electrical resistance, thereby increasing the amount of the active material and thus the energy density.

Among various conductive materials, Ketjen Black has shown superior conductivity. For example, the same or better conductivity can be obtained by adding only 6-10 wt % Ketjen Black compared to as much as 25 wt % Super-P or Acetylene black. However, Ketjen Black has a stronger hydrophobicity than other conductive materials (e.g., Super-P or Acetylene black) and thus is not easily mixed with the active material to make a slurry. If the Ketjen Black is used in the process of making an electrode without any consideration for this stronger hydrophobicity, the viscosity is increased, fluidity is not formed, and/or a slurry having the fluidity is formed but the efficiency of the process deteriorates.

Thus, since Ketjen Black has a superior conductivity and a very high hydrophobicity, and is not easily mixed with the active material, it is not well dispersed in the slurry of the electrode. Accordingly, even when Ketjen Black is used for making an electrode, it is very difficult to obtain the benefit of Ketjen Black's superior conductivity compared with Acetylene Black or Super-P.

A method is provided of manufacturing an electrode for an EDLC, pseudocapacitor, or battery that includes mixing an active material, a conductive material and a binder. In this method, Ketjen Black is used as the conductive material and a fluorosurfactant is used as an additive to enhance the fluidity of the slurry. Also, an electrode for an EDLC, pseudocapacitor, or battery, and an EDLC, pseudocapacitor, or battery using the electrode is provided. Use of the electrode made by this method increases the amount of the active material, thereby increasing the energy density without the adverse consequences to electrical resistance.

According to one exemplary embodiment of the present invention, the electrode material composition includes an active material, a conductive material comprising Ketjen Black, a binder comprising at least one of a polymer emulsion dispersed in water and a water-soluble polymer mixture, and a surfactant. In various embodiments, the electrode material composition comprises by weight about 1.0% to about 20% Ketjen Black. Alternatively, the electrode material composition comprises by weight about 3.0% to about 10% Ketjen Black.

In one aspect of the invention, the binder can be, for example, a polymer emulsion dispersed in water or a water-soluble polymer mixture. In various embodiments, the binder comprises a water-soluble cellulose binder, a water-soluble vinylene binder including a PVA, a PTFE dispersion, or a rubber emulsion.

In a further aspect of the invention, the surfactant can be, for example, a fluorosurfactant and can have a perfluorobutanyl group. In various embodiments, the electrode material comprises by weight about 0.05% to about 2.0% fluorosurfactant. Alternatively, the electrode material comprises by weight about 0.5% to about 1.5% fluorosurfactant.

In another exemplary embodiment of the present invention, a method for manufacturing an electrode includes dry-mixing an active material and a conductive material to form a dry-mixed active material mixture, mixing the dry-mixed active material mixture with a binder solution to form a slurry, adding an additive to the slurry to enhance fluidity of the slurry, and coating the slurry onto a current collector.

In one aspect of the invention, the conductive material comprises Ketjen Black. In various embodiments, the slurry comprises by weight about 1.0% to about 20% Ketjen Black. Alternatively, the slurry comprises by weight about 3.0% to about 10% Ketjen Black.

In a further aspect of the invention, the additive can be, for example, a fluorosurfactant and can have a perfluorobutanyl group. In various embodiments, the slurry comprises by weight about 0.05% to about 2.0% fluorosurfactant. Alternatively, the slurry comprises by weight about 0.5% to about 1.5% fluorosurfactant.

In yet another aspect of the invention, the binder solution can be, for example, a water-soluble cellulose binder, a water-soluble vinylene binder including a PVA, a PTFE dispersion, or a rubber emulsion.

### BRIEF DESCRIPTION OF THE DRAWINGS

A fuller understanding of the aspects, objects, features, and advantages of certain embodiments according to the invention will be obtained and understood from the following description when read together with the accompanying drawings, which primarily illustrate the principles of the invention and embodiments thereof. The drawings are not necessarily to scale and like reference characters denote corresponding or related parts throughout the several views. The drawings and the disclosed embodiments of the invention are exemplary only and not limiting on the invention.

FIG. 1 is a schematic diagram of an electrode in accordance with the present invention, including an electrode composite containing activated carbon, conductive carbon and binder, and a current collector.

FIG. 2 is a schematic diagram of the cathode, anode, and separator before winding.

FIG. 3 is a schematic diagram of an electric double layer cell after winding.

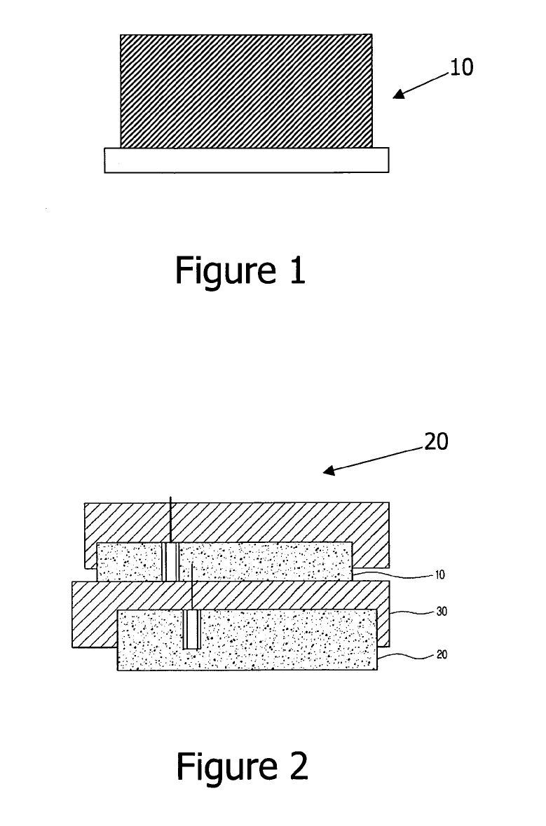

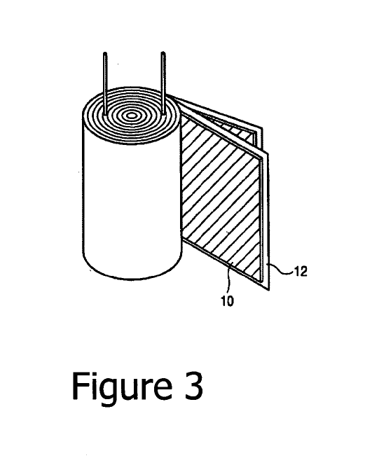

### DESCRIPTION

An electric double layer capacitor (EDLC) has a double layer, which is formed on a thin film of an article, with positive charges on one surface of the thin film and negative charges at the opposite surface of the thin film. The positive and negative charges are continuously positioned or distributed with the same surface density, and mainly composed of dipoles. Rearrangement of charges occurs at an interface between materials having different phases and an electric double layer is formed at the interface.

The electric double layer may be formed due to a selective adsorption of anyone of positive charge or negative charge at an interface between a solid electrode and an electrolyte, a dissociation of molecules from a surface of a solid, a configuration adsorption of dipoles toward an interface, or the like. Such an electric double layer has a close relation with various interfacial electrochemical phenomena (i.e., an electrode reaction, an interfacial electrokinetic phenomenon, a stable phase of a colloid, etc).

The EDLC, using the electric double layer, accumulates an electrical energy like a cell, formed by an electrostatic layer at an interface between an activated carbon electrode and an organic electrolyte, using an electric double layer state as a dielectric. The EDLC utilizes the principle that charges are absorbed to or desorbed from an interface between a solid electrode and an electrolyte. In particular, compared with a cell, the EDLC has a lower energy density, but has a superior discharge characteristic showing a high current and a high power instantly and has a semi-permanent lifetime due to several hundred thousand-cycle characteristics.

The EDLC is suitable for an auxiliary power for mobile information communication appliances requiring a rapid charge and discharge characteristic and a high power, such as a handheld terminal, a notebook computer or a PDA. The EDLC can also be used for a main power or an auxiliary power for a hybrid automobile, a signal lamp for a nighttime road, or an uninterruptible power supply, which requires a high capacitance.

Pseudocapacitors have a structure and characteristics similar to EDLCs, however, in pseudocapacitors a metal oxide is used as the active material for one of the two electrodes rather than activated carbon. The pseudocapacitor has greater potential for a higher energy density than the EDLC. The activated carbon in the EDLC utilizes surface area for energy storage, thus physically limiting potential energy density while the metal oxide technology of the pseudocapacitor utilizes a faradic reaction on the electrode surface similar to battery technology in addition to the EDLC mechanism for energy storage, thus improving potential energy density. Since the pseudocapacitor uses a dense metal oxide as the electrode material, the load of the oxide is three times that of the EDLC for the same coated area. With this advantage, pseudocapacitor cells occupy a much smaller volume as compared to an EDLC of the same capacitance. Similarly, the pseudocapacitor holds much more energy than the equivalent-size EDLC. Finally, the pseudocapacitor uses the same manufacturing processes and facilities as EDLC production. The only significant distinction is that a pseudocapacitor electrode replaces one of the EDLC electrodes.

Currently there are two different processes used for making activated carbon electrodes for a EDLCs, pseudocapacitors, and secondary batteries. The first process involves mixing together an active material in powder form, a small amount of a solvent such as water, and a binder such as polytetrafluoroethylene (PTFE) or similar material to form a paste. The paste is compressed onto a conductor to form an electrode. This process has an increased energy density due to the high density of the electrode. The active material, solvent, and binding agent are easily mixed regardless of the surface characteristics of the powder. However, this mixture is difficult to impregnate with an electrolyte and it is difficult to obtain a thin electrode of a thickness less than 30 μm. This process is therefore mainly used in energy backup for an electronic circuit that does not require a low resistance characteristic.

The second process for making an electrode involves mixing an active material in powder form, a binder polymer such as a polymer emulsion dispersed in water, that is preferably a styrene-butadiene emulsion or a water-soluble polymer such as carboxymethylcellulose (CMC) and a solvent such as water, to form a liquid or slurry in a having a viscosity similar to that of shampoo, coating the liquid onto a conductor, and then volatizing the solvent forming the electrode.

A more detailed explanation of the second process will now be described. The materials used for the second process includes activated carbon in powder form, a conductive material such as a carbon black in powder form, a polymer emulsion dispersed in water, such as Styrene-butadiene emulsion, a water-soluble polymer binder in powder form such as CMC or the like, and a solvent such as de-ionized water.

A dry mixing between the active powder material and conductive powder material is first performed using a ball mill for more than three hours for a uniform mixing; then the powders are mixed with the binder solution.

In recent years, a mixing of two or more binders is frequently used. In this case, a binder solution is made by mixing a water-soluble binder of cellulose such as a CMC with water of half a target water amount to obtain the first binder solution. An emulsion is then mixed with the remaining water to obtain the second binder solution. The two binder solutions are now sequentially mixed with the active material mixture. This resulting mixture is then mixed again in a planetary mixer for more than three hours to achieve a uniform electrode slurry mixture.

The binder performs both functions of binding the active materials together and binding to the current collector. The conductive material serves to decrease the electrical resistance of the electrode. The aforementioned binders are typically a polymer emulsion and a water-soluble polymer and the conductive material is typically a carbon black such as an Acetylene black or a Super-P.

The EDLC typically contains 75-85 wt % active material, 10-20 wt % conductive material, and 3-8 wt % binder. At this time, the conductive material is contained by at least 15 wt % so as to fabricate an EDLC having an electrical resistance characteristic of less than 1.5 Ohm Farads. The slurry is then thinly coated on an aluminum foil, which is used as a current collector, using a coater to complete the process of creating the electrode.

This second process, making the slurry having a predetermined viscosity, with an electrode having a low density, and a good degree of mixing performed with a physical property sharply varied depending on a surface characteristic of the powder, creates a situation where it is easy to impregnate with electrolyte and create an electrode of less than 10 μm thick. Since the process for the production of the electrode can be continuously performed, an electrode of more than a few hundred meters can easily be produced. This process is used for making an EDLC for power backup of more than a few hundred Farads requiring a low resistance and a high capacitance.

The important step in the process of making the electrode using the slurry is the partial process of mixing the binder solution and the active material mixture. Since the active material mixture comprises an activated carbon and a conductive material, it has a very high hydrophobicity, which is not easily mixed with water. Additionally, the active material may be in a paste-like state that does not have fluidity when being first mixed with a polymer emulsion. This paste state makes it difficult to form an electrode. In particular, an activated carbon such as Ketjen Black or the like, which has been frequently used in recent years, does not have impurities on its surface, and has a very strong hydrophobicity. It therefore is not easily mixed with water and thus difficult to make a slurry with fluidity.

To enhance the performance of the aforementioned EDLC, an increase in the energy density per volume is highly desired. The easiest method is to increase the amount of active material. To achieve this, decreasing the amount of conductive material can be considered. This conductive material is essential in decreasing the electrical resistance of the electrode and is made by adding a polymer (for example, carbon black) to an insulator polymer such as polycarbonate or polypropylene to decrease the electrical resistance and increase the conductivity, thereby preventing static electricity.

The drawback of this method is that decreasing the conductive material and increasing the amount of active material increases electrical resistance. Table 1, below, shows the variations in the electrical resistance as a function of the active material to the amount of conductive material.

TABLE 1
Variation in Electrical Resistance

| | | | Conduc- | | | |
|---|---|---|---|---|---|---|
| | Active | | tive | AC | DC | Capaci- |
| | Material | Binder | Material | Resistance | Resistance | tance |
| Comp. | (wt %) | (wt %) | (wt %) | (mOhm) | (mOhm) | (F) |
| 1 | 75 | 8 | 17 | 14 | 20 | 50 |
| 2 | 81 | 8 | 11 | 20 | 30 | 54 |
| 3 | 86 | 8 | 6 | 35 | 60 | 58 |

Active material: BP20 (Kuraray Chemical)
Binder: SBR resin (Nippon Zeon) + Carboxymethylcellulose
Conductive material: Super-P (MMM carbon)

As seen from the above Table 1, as the amount of active material increases, the capacitance increases but the AC resistance and the DC resistance increase as well. Accordingly, as suggested with composition 3, in the case of using a decrease in the amount of conductive material (i.e., Super-P) of 6 wt %, and an increase in the amount of active material of 86 wt % will increase the capacitance of the electrode. However, this method causes a large increase in the electrical resistance which is unsuitable for the EDLC. The DC resistance of composition 3 is three times larger than that of composition 1 in which the amount of the active material is 75 wt % and the amount of the conductive material is 17 wt %.

In the case of using the conventional conductive material (i.e., Super-P), a decrease in the amount of the conductive material can be considered so as to increase the capacitance of the electrode by increasing the amount of the active material. However, this method and material ingredients causes a large increase in the electrical resistance. Accordingly, there is a need to develop a method that can decrease the amount of the conductive material and at the same time prevent an increase in the electrical resistance so as to increase the amount of the active material.

Among various carbon blacks, the inventor has paid particular attention to Ketjen Black because of its superior conductivity. An even amount of Ketjen Black, corresponding to half an amount of Acetylene black or Super-P shows a better performance than the amount normally used. For example, conductivity obtained when the Acetylene black is added by 25 wt % can be obtained by adding only 6-10 wt % Ketjen Black. It is known that this advantage of the Ketjen Black is due to a wide specific surface area and a superior electrical conductivity.

However, the substitution of the Super-P with the Ketjen Black makes it difficult forming a slurry and shows poor electrical properties even when small amounts of Ketjen Black is added. This is because the Ketjen Black has a stronger hydrophobicity than do conventional conductive materials and thus is not easily mixed with the active material while the slurry is made. Normally, if the Ketjen Black is applied to the process of making the conventional EDLC, without any consideration, the viscosity is increased, fluidity is not formed, and/or a slurry having the fluidity is formed but a process for efficiency deteriorates. This phenomenon remarkably occurs when a rubber type emulsion such as Styrene-butadiene is used as a binder.

Thus, since the Ketjen Black has a superior conductivity and a very high hydrophobicity, and is not easily mixed with the active material, it is not well dispersed in the slurry of the electrode. Accordingly, even when the Ketjen Black is used for making an EDLC electrode in reality, it is very difficult to confirm the effect of the Ketjen black compared with the Acetylene Black or Super-P.

The embodiments disclosed hereinbelow provide an electrode for an electric double layer capacitor, a method of manufacturing the electrode, and an electric double layer capacitor using the electrode that can lower an electrical resistance of the electrode with a less amount of conductive material thereby increasing the capacitance with increased amount of active material.

The embodiments further provide an electrode for an electric double layer capacitor, the electrode being manufactured using a slurry having a good fluidity and a less amount of conductive material, a method of manufacturing the electrode, and an electric double layer capacitor using the electrode.

An electrode for an electric double layer capacitor includes: an active material; a Ketjen Black used as a conductive material; a binder comprising a polymer emulsion dispersed in water and a water-soluble polymer mixture; and a surfactant for enhancing fluidity of a slurry, the slurry being formed when the Ketjen Black is mixed with the binder. The Ketjen Black may be used in a range of 1-20 wt % with respect to a total weight of the electrode, preferably, in a range of 3-10 wt %. The surfactant may be a fluorosurfactant having a perfluorobutanyl group. The fluorosurfactant is used in a range of 0.05-2 wt % with respect to a total weight of the electrode, preferably in a range of 0.5-1.5 wt %.

The binder may be made of a water-soluble cellulose binder, a water-soluble vinylene binder including PVA, a PTFE dispersion, and/or a rubber emulsion.

In another embodiment, a method for manufacturing an electrode for an electric double layer capacitor includes dry-mixing an active material and a conductive material to prepare a dry mixed active material mixture; mixing the dry-mixed active material with a binder solution to form a slurry; and coating the slurry on a current collector, wherein the forming of the slurry is improved with an additive so as to enhance the fluidity of the slurry formed by the active material mixture and the binder.

In still another embodiment, and electric double layer capacitor includes at least two electrodes including a cathode and an anode; a separator separating the electrodes; and an electrolyte contacting the electrodes to form an electric double layer at a contact surface between the electrolyte and the electrodes, the electrode comprises an active material; a binder; a Ketjen Black used as a conductive material; and an additive for enhancing fluidity of a slurry, the slurry being formed when the Ketjen Black is mixed with the active material and the binder.

The present invention is hereinbelow described in more detail. As described above, in cases where a conductive material having a high hydrophobicity, such as Ketjen Black, is used for manufacturing an EDLC, the slurry does not have a desired degree of fluidity. For example, in cases where a slurry is formed using a rubber binder and an activated carbon having a specific surface area of more than 1500 m²/g, the slurry has a high viscosity or fails to have fluidity in many cases.

To solve these problems an addition of a surfactant to the slurry allows the Ketjen Black to be well mixed with a mixture of the slurry and a conductive material, thus enhancing the fluidity and lowering the resistance. At this time, to obtain satisfactory results without causing a variation in the physical property of the electrode, it is preferable to use a surfactant that can greatly reduce the surface energy of a solvent to an amount as small as possible.

The present inventor has discovered that a fluorosurfactant should preferably be used as the surfactant. Since even a small amount of the fluorosurfactant can greatly lower the surface energy of water, and since the fluorosurfactant is very stable even in an electrical reaction, it does not have a great influence on the electrode even though it remains on the electrode. With the fluorosurfactant, Ketjen Black is well mixed with the slurry.

In addition, the present inventor has found that a fluorosurfactant having a perfluorobutanyl group should be preferably used as the surfactant. At this point, although a surfactant having a perfluorooctanyl group shows the best effect, its use has recently been prohibited due to the fact that the surfactant in the natural world causes an environmental toxicity. Accordingly, it is preferable to use a fluorosurfactant having a perfluorbutanyl group.

In particular, the fluorosurfactant is suitable for the manufacturing process of an EDLC because it has the following advantages:

1. The fluorosurfactant is a non-ionic surfactant unlike a typical surfactant. Accordingly, since the fluorosurfactant does not change a pH of a solvent, it does not influence pH characteristics of an active material and a binder which can be easily applied to a process. The degree of mixing carbon powders with water is greatly influenced by a pH value. Also, a pH value of a Styrene-Butadiene emulsion shows a weak acid between 5 and 6, and a pH value of a CMC is above 9; therefore the solubility of the CMC is greatly varied as the pH value changes. Accordingly, there is a need for a surfactant, not having a sensitive variation in pH value, and the fluorosurfactant is excellent in this manner.

2. The fluorosurfactant shows a considerably superior viscosity variation even at a small amount (less than 0.5 wt %). Accordingly, it is not necessary to add a large amount of the fluorosurfactant to achieve a beneficial effect.

3. The fluorosurfactant is excellent in thermal and chemical stability. When an electrode is used in an EDLC, the electrode is placed under a strong oxidation and reduction condition. Upon considering the characteristic of the fluorosurfactant, since the fluorosurfactant is superior in the chemical stability, it has a small decomposability. And, upon considering the electrode manufacturing process, the fluorosurfactant is subject to a hot pressing process at about 150° C. However, since the fluorosurfactant has a superior thermal stability, it does not decompose.

Among the fluorosurfactants, FC-4430 and FC-4432 supplied by 3M Corporation are most useful. According to 3M Corporation, water generally has a surface tension of 73 dynes/cm. When 0.2 wt % FC-4430 is added to the water, the surface tension of the water is decreased to 21 dynes/cm, and when 0.5 wt % FC-4430 is added to the water, the surface tension of the water is decreased to 20 dynes/cm. Thus, the addition of a small amount of the FC-4430 greatly decreases the surface tension of the water. If this product is added as an additive to a slurry, the viscosity of the slurry which does not nearly have a fluidity and includes the Ketjen Black is greatly decreased to generate the fluidity, so that processability is enhanced. Also, since the dispersibility of the Ketjen Black is improved, an addition of 8 wt % of the Ketjen Black makes it possible to obtain an equal resistance to that of 17 wt % of the Super-P.

Thus, the use of the fluorosurfactant solves the dispersibility problem of the Ketjen Black, so that the conductive material of the Ketjen Black can be well dispersed. In particular, the addition of the fluorosurfactant, even at a small amount, enhances the dispersibility and the production processability of the Ketjen Black can lower the electrical resistance. Especially since the use of a small amount of the conductive material makes it possible to additively use an active material by a decreased amount of the conductive material, a specific capacitance (energy density) per volume is enhanced. By employing those techniques of the present invention, an enhancement in the specific capacitance of more than 10% is expected compared with the related art.

In manufacturing electric double layer capacitors, the use of the fluorosurfactant enhances the processability of the slurry containing the Ketjen Black and makes it possible to manufacture an EDLC having a sufficiently low resistance value even at a small amount of the Ketjen Black.

While the method of manufacturing the electric double layer capacitor according to the present invention is preferentially applied to an EDLC made by using water as a solvent, it can be applied even to an EDLC made by using an organic solvent. In particular, a fluoro binder can act on most organic solvents as well as on the water to lower the viscosity. Also, the binder can be applied to a polymer emulsion binder, a water-soluble cellulose such as methylcellulose, carboxymethylcellulose or the like, a dispersion such as PTFE, and a water-soluble vinylene polymer such as PVA.

### Embodiments

Hereinafter, reference is made in detail to experimental examples using an electrode of an EDLC according to the present invention.

a) Comparison between an EDLC using a conventional Super-P and an EDLC of the present invention. EDLCs of comparative examples 1 and 2 were made using a Super-P and an EDLC of an embodiment 1 was made as below.

### Manufacturing of Comparative Example 1

75 g BP20 (Kuraray Chemical) which is an active material, and 17 g Super-P (MMM Carbon) powder was mixed together to form a first mixture. A binder solution was also prepared by adding 3 g sodium carboxymethylcellulose (Nippon Zeon) and 12.5 g styrene-butadiene rubber emulsion (40% emulsion from Nippon Zeon) in water, and then mixed with the first mixture of the active material and the conductive material to form a second mixture. The second mixture was wet-mixed for 4 hours to form a slurry solution. The slurry solution had a viscosity of about 3000 cps. The slurry solution was prepared by mixing the active material, the conductive material and the binder was coated on both surfaces of an etched aluminum foil (CB 20 from Nippon aluminum foil) functioning as a current collector and having a thickness of 20 μm to about 100 μm to make an electrode. The electrode was dried and then made into an anode and a cathode. The final electrode had a width of 3 cm and a length of 40 cm. An aluminum terminal generally used in an aluminum condenser was attached on the made final electrode. The electrode was wound together with a separator (TF4035 from NKK). After that, propylene carbonate containing 1M tetraethylammonium tetrafluoroborate ((C₂H₅)₄NBF₄) was impregnated, and a resultant article was placed in a cylindrical case having a diameter of 18 mm and a height of 40 mm and then sealed to complete a final product.

Manufacturing of Comparative Example 2

An EDLC of comparative example 2 was prepared in the same manner except that the composition ratios of the active material and the conductive material were changed. 85 g BP20 (Kurary Chemical) which is the active material, and 7 g Super-P powder was used, and the composition of the binder solution, the process, the condition of the electrolyte and the like were kept in the same conditions to manufacture the EDLC of the comparative example 2.

Manufacturing of Inventive Example 1

85 g BP20 (Kuraray Chemical) which is an active material, and 7 g EC 600 JD (Mitsubishi Chemical) powder which is one type of Ketjen Blacks were mixed to form a first mixture. A binder solution was also prepared by adding 3 g sodium carboxymethylcellulose (Nippon Zeon), 12.5 g styrene-butadiene rubber emulsion (40% emulsion from Nippon Zeon), and 1 g FC-4430 (3M fluorosurtactant), which is a fluorosurfactant, in water. The binder solution was then mixed with the first mixture of the active material and the conductive material, forming a final active material slurry. An EDLC having a diameter of 18 mm and a height of 40 mm was made using the formed final active material slurry in the same manner as that of comparative example 1.

Compositions and characteristics of Comparatives 1 and 2, and inventive example 1 were measured to obtain results shown in Table 2, below.

TABLE 2
Variation in Performance Dependant on Conductive Material

| | | | Conduc- | | | |
|---|---|---|---|---|---|---|
| | Active | | tive | AC | DC | Capaci- |
| | Material | Binder | Material | Resistance | Resistance | tance |
| Comp. | (wt %) | (wt %) | (wt %) | (mOhm) | (mOhm) | (F) |
| Inv | 85 | 8 | 17 | 15 | 24 | 57 |
| Ex. 1 | | | | | | |
| Comp. | 75 | 8 | 17 | 14 | 20 | 50 |
| Ex. 1 | | | | | | |
| Comp. | 85 | 8 | 7 | 33 | 60 | 57 |
| Ex. 2 | | | | | | |

As seen from Table 2, comparing the measured results among the inventive example 1, and the comparative examples 1 and 2, the advantages of the present invention can be confirmed. Although the inventive example 1 used much more active material than the comparative example 1, similar resistance values were obtained. Also, the inventive example 1 obtained a capacitance enhanced by 10% compared with the comparative 1. Accordingly, when the technique of the present disclosure is employed, the capacitance in the same volume is increased without a great variation in the resistance value.

b) Comparison between a product to which a fluorosurfactant is added and a product to which a fluorosurfactant is not, in which each product contains a Ketjen Black. An EDLC of comparative example 3 having the same composition as that of the inventive example 1 and not containing a fluoro-additive was manufactured to compare effects of the fluoro-additive.

Manufacturing of Comparative Example 3

Like in the inventive example 1, 85 g BP20 and 7 g EC 600 JD (one type of Ketjen Black carbon made from Mitsubishi Chemical) powder was mixed to form a mixture. A binder solution was also prepared by mixing 12.5 g styrene-butadiene rubber emulsion and 3 g sodium carboxymethylcellulose with 300 g water. After that, the binder solution was incorporated into the mixture. Under the above conditions, because the slurry between the binder solution and the mixture powder is not well formed, since this mixture has a very high viscosity of more than 10000 cps, and does not create a fluidity, it is possible to make a final slurry after addition of a solvent of much more than 100 g and a mixing for 4 hours. An EDLC was made using the obtained final slurry in the same condition as that of the inventive embodiment 1. Characteristics of the inventive example 1 and the comparative example 3 were measured as shown in Table 3, below.

TABLE 3
Variation in Physical Properties Dependant on Flurosurfactant

| | | | Conduc- | | | |
|---|---|---|---|---|---|---|
| | Active | | tive | AC | DC | Capaci- |
| | Material | Binder | material | resistance | resistance | tance |
| Comp. | (wt %) | (wt %) | (wt %) | (mOhm) | (mOhm) | (F) |
| Inv | 85 | 8 | 7 | 15 | 24 | 57 |
| Ex. 1 | | | | | | |
| Com | 85 | 8 | 7 | 30 | 55 | 52 |
| Ex. 3 | | | | | | |

The case of the comparative example 3 made without adding a fluorosurfactant FC-4430 shows similar characteristics to that of comparative example 2 in which Super-P having the same content is used as a conductive material. AC resistance of the comparative example 3 is two times larger than that of the inventive example 1 but the capacitance is not nearly changed. This means that use of Ketjen Black does not show an effect. The increase of the active material did not result in the increase in the capacitance. This means that since an increase of the solvent lowers the density of the electrode, an increase in the capacitance of the final EDLC is not generated.

c) Effects on ratios of Ketjen Black when a constant amount of fluorosurfactant is used. EDLCs of inventive examples 2, 3 and 4 were manufactured, containing 0.3 wt % fluorosurfactant with respect to a total composition of the solvent at different ratios of Ketjen Black.

Manufacturing of Inventive Example 2

75 g BP20 and 17 g EC 600 JD was mixed to prepare an active material powder. A binder solution was also prepared by adding 3 g sodium carboxymethylcellulose (Nippon Zeon), 12.5 g styrene-butadiene rubber emulsion (Nippon Zeon), and 1 g FC-4430 (3M fluorosurfactant) in 300 g water. After that, the binder solution was mixed with the active material powder to prepare a final active material slurry. An EDLC having a diameter of 18 mm and a height of 40 mm was made using the formed final active material slurry in the same manner as that of the inventive example 1.

Manufacturing of Inventive Example 3

80 g BP20 and 12 g EC 600 JD was mixed to prepare an active material powder. A binder solution was also prepared by adding 3 g sodium carboxymethylcellulose (Nippon Zeon), 12.5 g styrene-butadiene Rubber emulsion (Nippon Zeon), and 1 g FC-4430 (3M fluorosurfactant) in 300 g water. After that, the binder solution was mixed with the active material powder to prepare a final active material slurry. An EDLC having a diameter of 18 mm and a height of 40 mm was made using the formed final active material slurry in the same manner as that of the inventive example 1.

Manufacturing of Inventive Example 4

90 g BP20 and 2 g EC 600 JD was mixed to prepare an active material powder. A binder solution was also prepared by adding 3 g sodium carboxymethylcellulose (Nippon Zeon), 12.5 g styrene-butadiene rubber emulsion (Nippon Zeon), and 1 g FC-4430 (3M fluorosurfactant) in 300 g water. After that, the binder solution was mixed with the active material powder to prepare an active material slurry. The prepared active material slurry did not show a fluidity due to a high viscosity of the solvent. Accordingly, a final active material slurry was made by adding 50 g water to the prepared active material slurry. An EDLC having a diameter of 18 mm and a height of 40 mm was made using the formed final active material slurry in the same manner as that of the inventive example 1.

Characteristics of the inventive examples 2, 3 and 4 were measured as shown in Table 4, below.

TABLE 4
Variation in Physical Properties Depending Conductive Material

| | | | Conduc- | | | |
|---|---|---|---|---|---|---|
| | Active | | tive | AC | DC | Capaci- |
| | Material | Binder | Material | resistance | resistance | tance |
| Comp. | (wt %) | (wt %) | (wt %) | (mOhm) | (mOhm) | (F) |
| Inv | 85 | 8 | 7 | 15 | 24 | 57 |
| Ex. 1 | | | | | | |
| Inv. | 75 | 8 | 17 | 13 | 23 | 50 |
| Ex. 2 | | | | | | |
| Inv. | 80 | 8 | 12 | 14 | 23 | 54 |
| Ex. 3 | | | | | | |
| Inv. | 90 | 8 | 2 | 20 | 40 | 55 |
| Ex. 4 | | | | | | |

The EDLCs were manufactured by varying only the amount of the conductive material while keeping the amount of the FC-4430 to 1 g and the amount of the binder to a constant amount. After that, AC and DC resistance of the manufactured EDLCs were measured. From the above table 4, it is confirmed that when the amount of conductive material is decreased below a predetermined value, the resistance is greatly increased. Also, if the amount of the conductive material is increased above a predetermined amount, it is confirmed that a decrease effect of the resistance is not so pronounced and the capacitance is reduced by a decrease in the ratio of the active material. Accordingly, it is more advantageous in optimizing the capacitance and the resistance to maintain a proper ratio of the activated carbon and the conductive material.

d) Effects on the amount of fluorosurfactant when the ratio of Ketjen Black is constant. In inventive examples 5 and 6, effects were obtained based on the amount of fluorosurfactant.

Manufacturing of Inventive Example 5

75 g BP20 and 17 g EC 600 JD was mixed to prepare an active material powder. A binder solution was also prepared by adding 3 g sodium carboxymethylcellulose (Nippon Zeon), 12.5 g styrene-butadiene rubber emulsion (Nippon Zeon), and 1 g FC-4430 (3M fluorosurfactant) which is a fluorosurfactant, in 300 g water. After that, the binder solution was mixed with the active material powder to prepare an active material slurry. At this time, since the prepared active material slurry has a fluidity but a high viscosity, the experiment was performed after adding 30 g of water. An EDLC having a diameter of 18 mm and a height of 40 mm was made in the same manner as that of the inventive example 1.

Manufacturing of Inventive Example 6

75 g BP20 and 17 g EC 600 JD was mixed to prepare an active material powder. A binder solution was also prepared by adding 3 g sodium carboxymethylcellulose (Nippon Zeon), 12.5 g styrene-butadiene rubber emulsion (Nippon Zeon), and 1 g FC-4430 (3M fluorosurfactant) which is a fluorosurfactant, in 300 g water. After that, the binder solution was mixed with the active material powder to prepare a final active material slurry. An EDLC having a diameter of 18 mm and a height of 40 mm was made in the same manner as that of the inventive example 1.

TABLE 5
Variation in Physical Properties Dependant on Conductive Material

| | | | Conduc- | | | | |
|---|---|---|---|---|---|---|---|
| | Active | | tive | | AC | DC | Capaci- |
| | Material | Binder | Material | Surfactant | resistance | resistance | tance |
| Comp. | (wt %) | (wt %) | (wt %) | (g) | (mOhm) | (mOhm) | (F) |
| Inv | 85 | 8 | 7 | 1 | 15 | 24 | 57 |
| Ex. 1 | | | | | | | |
| Inv. | 85 | 8 | 7 | 0.25 | 13 | 23 | 50 |
| Ex. 5 | | | | | | | |
| Inv. | 85 | 8 | 7 | 0.5 | 14 | 23 | 54 |
| Ex. 6 | | | | | | | |
| Inv. | 85 | 8 | 7 | 2 | 20 | 40 | 55 |
| Ex. 7 | | | | | | | |

After the EDLCs were manufactured, while maintaining other conditions and varying the amount of the surfactant, their performances were evaluated. If the amount of the surfactant exceeds a predetermined amount, additional variations in the resistance and capacitance are not observed. Accordingly, it is unnecessary to add the surfactant above a predetermined amount. Like in the inventive example 5, when the amount of the added surfactant is below a predetermined value, it is confirmed that the resistance is increased, the capacitance is decreased, and the processability is deteriorated. Accordingly, it is very important to use a suitable amount of surfactant for the optimization of performance.

Although embodiments have been described with reference to a number of illustrative embodiments thereof, it should be understood that numerous other modifications and embodiments can be devised by those skilled in the art that will fall within the spirit and scope of the principles of this disclosure. More particularly, different variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

Since other modifications and changes varied to fit particular operating requirements and environments will be apparent to those skilled in the art, the invention is not considered limited to the example chosen for purposes of this disclosure, and covers all changes and modifications which do not constitute departures from the true spirit and scope of this invention.

Having thus described the invention, what is desired to be protected by Letters Patent is presented in the subsequently appended claims.

What is claimed is:

1. An electrode material composition, comprising:
a) an active material;
b) a conductive material, the conductive material comprising Ketjen Black;
c) a binder, the binder comprising at least one of a polymer emulsion dispersed in water and a water-soluble polymer mixture; and
d) a surfactant.

2. The electrode material composition according to claim 1, wherein the surfactant comprises a fluorosurfactant.

3. The electrode material composition according to claim 2, wherein the fluorosurfactant comprises a perfluorobutanyl group.

4. The electrode material composition according to claim 1, wherein the binder comprises a polymer emulsion dispersed in water and a water-soluble polymer mixture.

5. The electrode material composition according to claim 2 comprising by weight about 0.05% to about 2.0% fluorosurfactant.

6. The electrode material composition according to claim 2 comprising by weight about 0.5% to about 1.5% fluorosurfactant.

7. The electrode material composition according to claim 1 comprising by weight about 1.0% to about 20% Ketjen Black.

8. The electrode material composition according to claim 1 comprising by weight about 3.0% to about 10% Ketjen Black.

9. The electrode material composition according to claim 1, wherein the binder comprises at least one binder selected from the group comprising a water-soluble cellulose binder, a water-soluble vinylene binder including a PVA, a PTFE dispersion, and a rubber emulsion.

10. A method for manufacturing an electrode, the method comprising:
a) dry-mixing an active material and a conductive material to form a dry-mixed active material mixture;
b) mixing the dry-mixed active material mixture with a binder solution to form a slurry;
c) adding an additive to the slurry to enhance fluidity of the slurry; and
d) coating the slurry onto a current collector.

11. The method according to claim 10, wherein the conductive material comprises Ketjen Black.

12. The method according to claim 11, wherein the slurry comprises by weight about 1.0% to about 20% Ketjen Black.

13. The method according to claim 11, wherein the slurry comprises by weight about 3% to about 10% Ketjen Black.

14. The method according to claim 10, wherein the additive comprises a fluorosurfactant.

15. The method according to claim 14, wherein the slurry comprises by weight about 0.05% to about 2.0% fluorosurfactant.

16. The method according to claim 14, wherein the slurry comprises by weight about 0.5% to about 1.5% fluorosurfactant.

17. The method according to claim 14, wherein the fluorosurfactant comprises a perfluorobutanyl group.

18. The method according to claim 10, wherein the binder solution comprises a water-soluble cellulose binder.

19. The method according to claim 10, wherein the binder solution comprises a water-soluble vinylene binder

20. The method according to claim 19, wherein the water-soluble vinylene binder includes a PVA.

21. The method according to claim 10, wherein the binder solution comprises a PTFE dispersion.

22. The method according to claim 10, wherein the binder solution comprises a rubber emulsion.
